(19) United States
(12) Patent Application Publication
(10) Pub. No.: US 2015/0260427 A1
(43) Pub. Date: Sep. 17, 2015

(54) CONNECTOR FRAME FOR DUCT BOOT

(71) Applicant: Darryl L. Snyder, Sarasota, FL (US)

(72) Inventor: Darryl L. Snyder, Sarasota, FL (US)

(21) Appl. No.: 14/215,566

(22) Filed: Mar. 17, 2014

(51) Int. Cl. F24F 13/08; B01D 46/00

(52) U.S. Cl. CPC F24F 13/085; B01D 46/0005

(57) ABSTRACT

A connector frame is used to secure a duct boot at a vent opening. The connector frame includes a mounting ledge that receives locking fingers disposed at the upper portion of a duct boot. One configuration of the connector frame defines tapered ribs that define a funnel to help locate the upper portion of the duct boot with respect to the mounting ledge. Different configurations of the connector frame include filters or seals to prevent debris from falling into the duct boot. The filter can be carried on stands above the mounting ledge. The stands can be located in recesses disposed outwardly of the mounting ledge.

### BACKGROUND OF THE DISCLOSURE

1. Technical Field

This disclosure generally relates to ducted heating, ventilation, and air-conditioning (HVAC) systems and is more particularly directed to the connections and installation of the ducts at the vents in floors. Specifically, the disclosure relates to a connector frame that provides an easy way to connect a duct boot to a floor at a vent opening.

2. Background Information

In modern home building construction, the HVAC system typically delivers air to a room through a sheet metal duct that is routed to a vent opening in a floor of the room. A preformed sheet-metal “boot” is fitted inside the perimeter of the floor opening for connection with the duct. The perimeter of the boot is sized to generally closely fit within the floor opening. Most boots are installed by nailing the boot sidewall to the floor boards with one or two nails. This method of connection leaves an air gap between the floor and the outer surface o the boot. This gap can allow air to leak.

Workers often allow the floor boot to remain uncovered during construction, and it is customary to operate the HVAC system to control the ambient temperature in the rooms under construction to permit the new materials (wood, flooring, wall boards, tiles, etc.) to become acclimatized to the heated air and cooled air during the construction period. As a result, wallboard dust, sawdust, nails, wood, metal and wire fragments, and other construction debris will often enter the boots and accumulate inside the ducts and associated HVAC equipment. Unless thoroughly removed when construction is finished, the accumulated debris can impair the operation of the HVAC system and can be expelled into the room. U.S. Pat. No. 6,749,499 discloses different embodiments of the vent cover that can seal the vent opening or provide filtering. U.S. Pat. No. 6,461,235 B2 discloses a temporary vent opening cover for covering a vent opening in a floor during building construction. U.S. Pat. No. 4,712,343 discloses a reusable shield to temporarily cover interior vent openings in residential and commercial HVAC systems. U.S. Pat. No. 6,835,129 discloses an HVAC duct boot sealing device that covers the duct boot during construction and when removed provides an improved vent seal after construction is finished. US 2004/0074214A1 is a filter devise to be mounted upon a register or air grille that will permit a slidable air filter to be replaced from time to time. U.S. Pat. No. 4,829,886 is a thermoplastic guard device that is a permanent debris or liquid catcher to be placed over vent openings. U.S. Pat. No. 6,908,115 is a register opening cover to be used until the boot is installed.

U.S. Pat. No. 6,601,356 discloses a connector frame for a ventilation opening wherein a louvered grille can be securely attached to the connector frame at a wall opening.

D494,265, D494,670 and D496,453 disclose frames used to connect the upper end of a duct to a floor at a ventilation opening.

### SUMMARY OF THE DISCLOSURE

The disclosure provides a connector frame that is used to secure a duct boot at a vent opening. The connector frame includes a mounting ledge that receives locking fingers disposed at the upper portion of a duct boot. The connection between the duct boot and the connector frame may be sealed and the connection between the connector frame and the floor may be sealed. A vent may be placed into and/or over the connector frame.

One configuration of the connector frame defines tapered ribs that define a funnel-shaped lower opening to help locate the upper portion of the duct boot with respect to the mounting ledge.

Another configuration uses a pocket formed from bendable sheet metal to receive a bent lip disposed at the top portion of the duct boot.

Different configurations of the connector frame include filters or seals to prevent debris from falling into the duct boot. The filter can be carried on stands above the mounting ledge so that the filter may be used with the duct boot installed on the mounting ledge. The filter stands can be located in recesses disposed outwardly of the mounting ledge.

### BRIEF DESCRIPTION OF THE DRAWINGS

FIG. 1 is a perspective view of the connector frame.

FIG. 2 is a top plan view of the connector frame.

FIG. 3 is a section view taken along line 3-3 of FIG. 2.

FIG. 4 is an exploded view of a vent, the connector frame, a section of floor with an opening, and the top of a duct boot.

FIG. 5 is a top perspective view showing the duct boot secured to the connector frame.

FIG. 6 is a section view taken along line 6-6 of FIG. 5.

FIG. 7 is a perspective view of a vent disposed over the connector frame.

FIG. 8 is a section view of a connector frame shown with a filter and a seal.

FIG. 9 is a section view of a portion of an alternative embodiment of a connector frame.

FIG. 10 is a section view of a portion of another alternative embodiment of a connector frame.

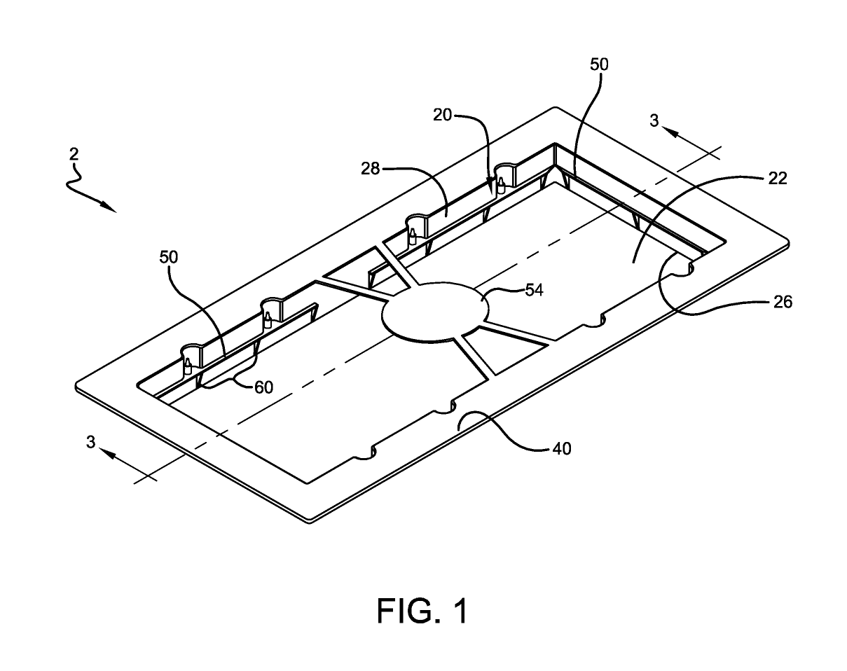

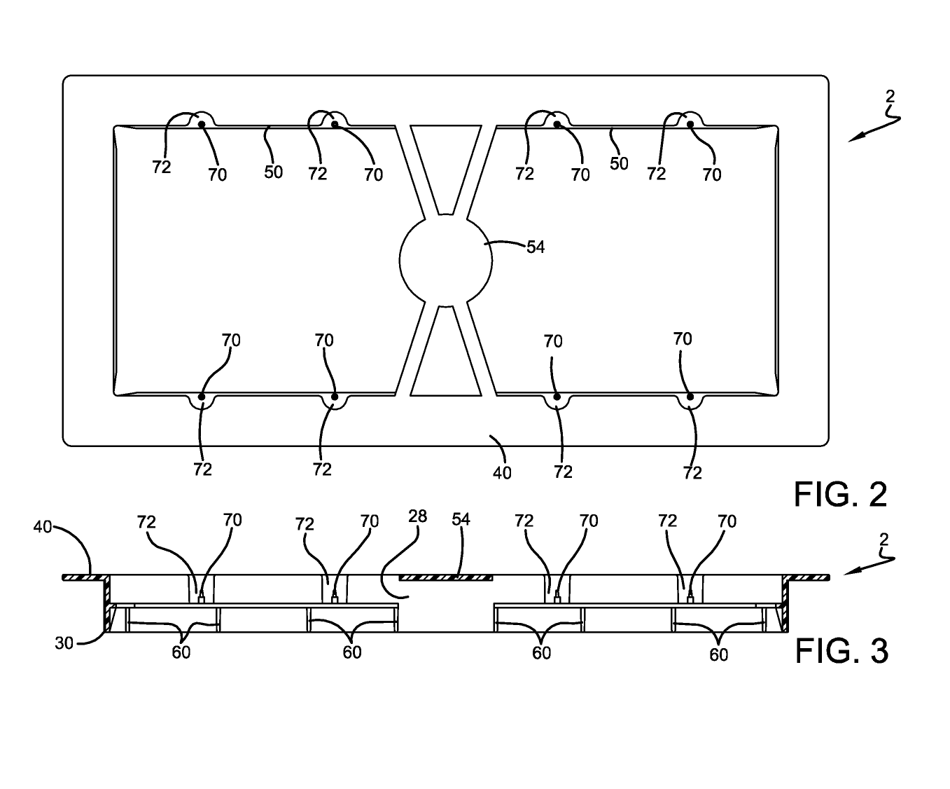

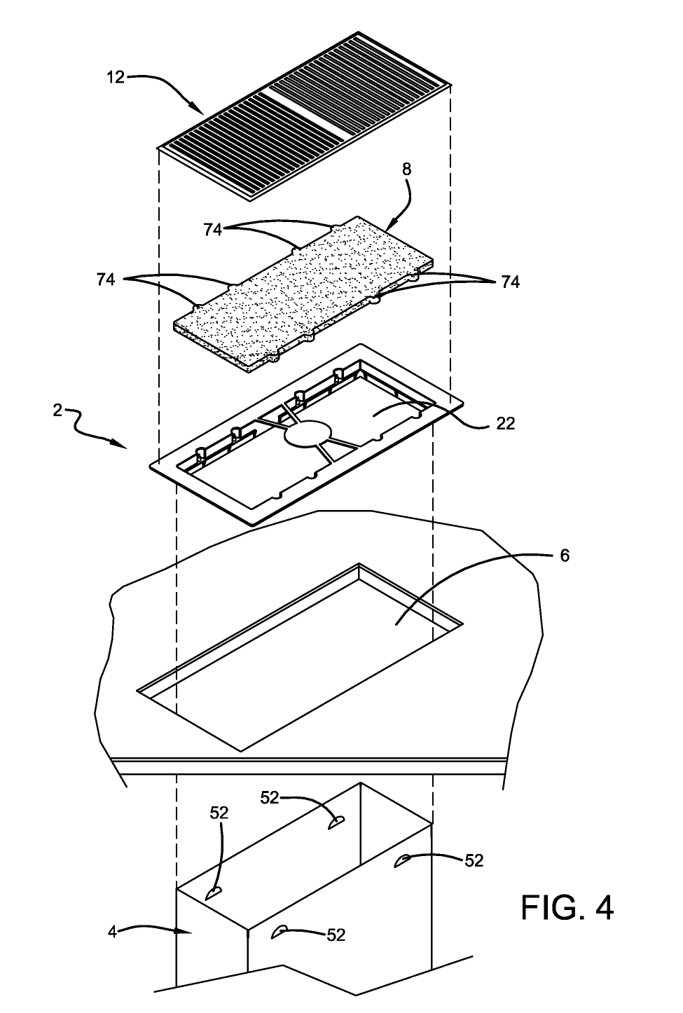

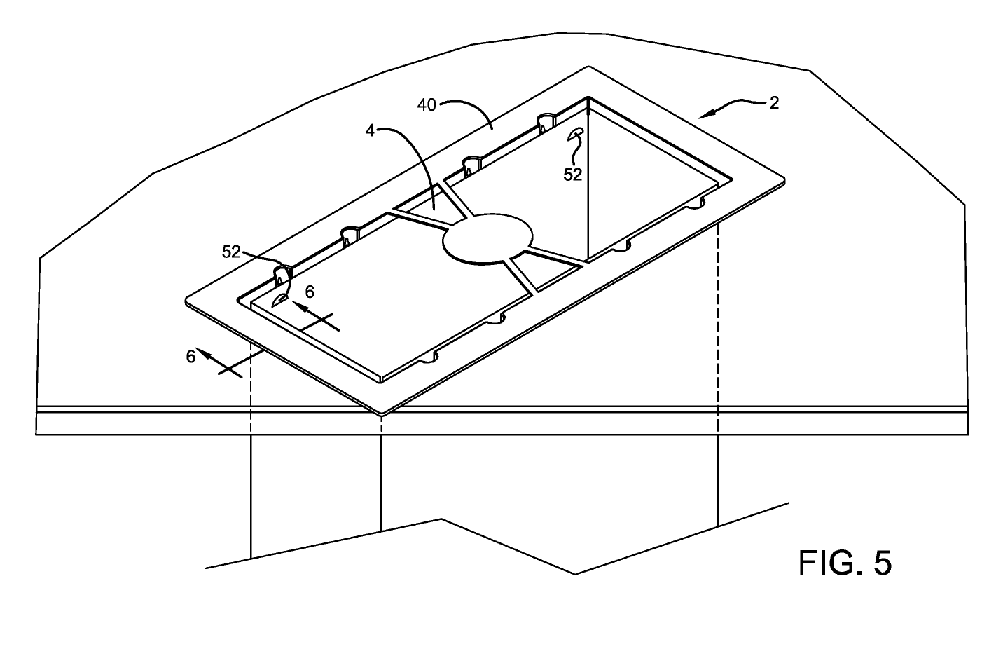

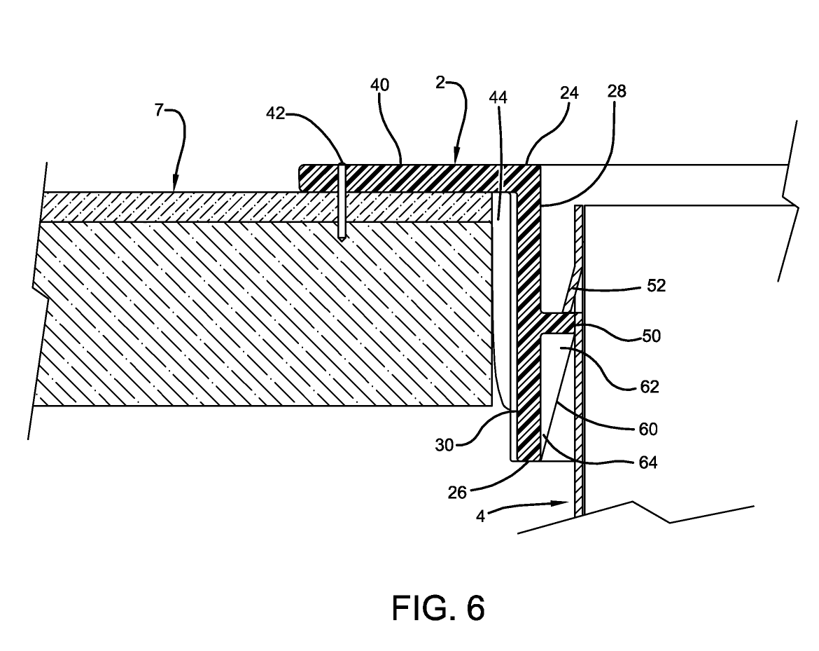

Similar numbers refer to similar parts throughout the application.

### DETAILED DESCRIPTION OF THE DISCLOSURE

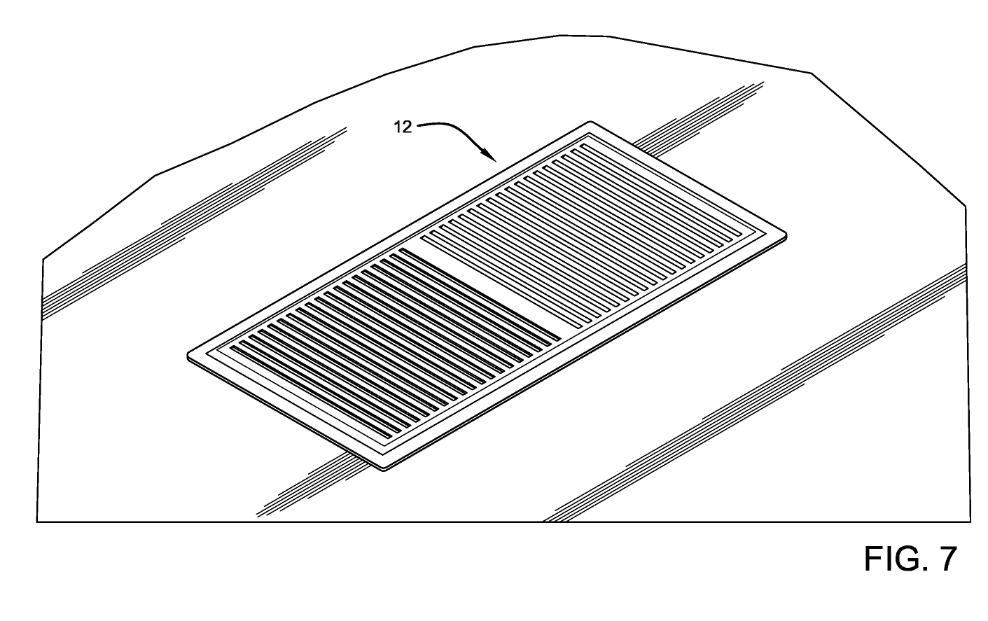

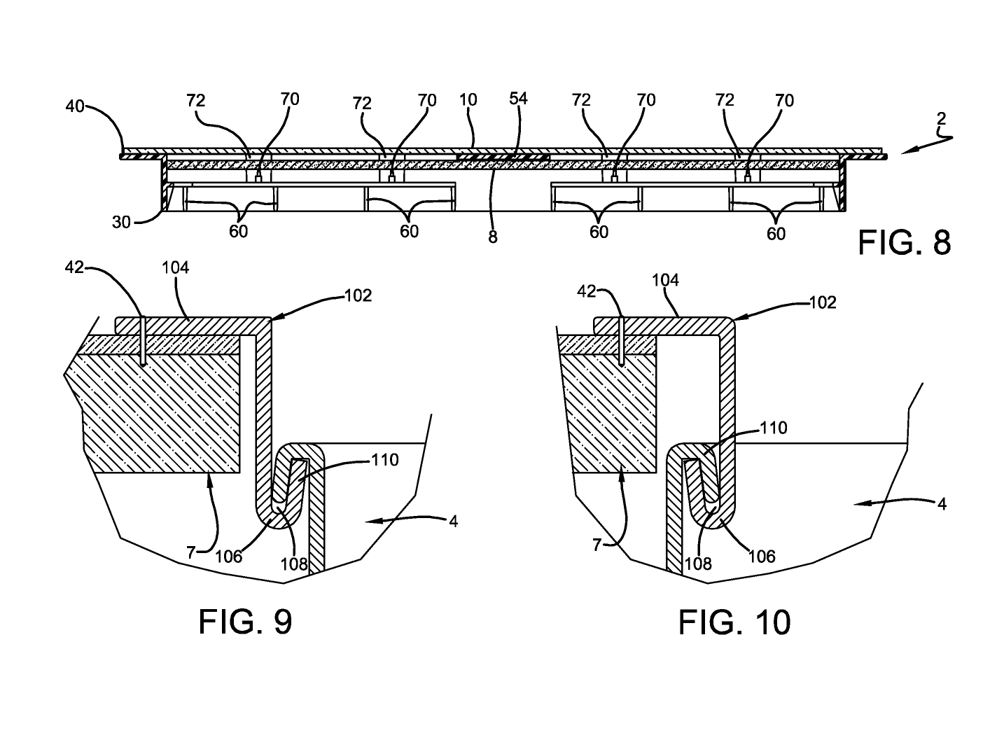

An exemplary connector frame is indicated generally by the numeral 2 in the accompany drawings. Connector frame 2 is used to mount a duct boot 4 at a floor vent opening 6 defined by a floor 7. After the duct boot 4 is installed, the joint between duct boot 4 and the floor may be sealed with tape to seal any air gaps. The joint between connector frame 2 and the floor also may be sealed with tape or with a sealant, an adhesive, or a layer of resilient material disposed between connector frame 2 and floor 7. Connector frame 2 thus may be used to form a connection between duct boot 4 and floor 7 with almost no air leaks. Connector frame 2 may include a filter 8 and/or a seal 10 (see FIG. 8) so that connector frame 2 may be used during construction to limit or prevent debris from entering duct boot 4 through floor vent opening 6. Connector frame 2 receives a traditional-style floor vent 12 that covers connector frame 2. Vent 12 also may include a body that extends down into the top of duct boot 4.

Connector frame 2 includes a body 20 that defines an opening 22 sized to receive the upper end of duct boot 4. Opening 22 is thus the same shape and slightly larger than the cross section the upper end of duct boot 4. Connector frame 2 may be provided in sizes for typical ducts such as 2.25 inches by 10, 12, or 14 inches and 4 inches by 10, 12, or 14 inches. Connector frame 2 also may be round and used, for example, with air conditioning delivery ducts that terminate in ceilings. Body 20 defines an upper end 24, a lower end 26, an inner surface 28, and an outer surface 30.

A flange 40 projects outwardly (away from the center of frame 2) from upper end 24 of body 20. When connector frame 2 is installed, flange 40 is disposed on top of the upper surface of the floor 7 that defines opening 6. Flange 40 is wide enough to extend beyond opening a distance sufficient to receive connectors 42 (such as staples, nails, screws, or adhesive) that secure flange 40 to the floor. Flange 40 is thin enough to readily receive staples from a standard staple gun. Flange 40 can be a quarter to three quarters inch wide. Flange 40 may be continuous and unbroken or defined by a plurality of spaced portions. A sealant or strip of sealing or resilient material may be positioned under flange 40. The sealant or strip of material may be provided with frame 2 or added by the person installing frame 2.

A plurality of spaced positioning ribs 44 project outwardly from the outer surface of body 20 under flange 40. Positioning ribs 44 provide rigidity to body 20 and reduce friction between body 20 and the floor when body 20 is being slid down into floor opening 6. Ribs 44 are tapered or have rounded lower edges to provide for easy insertion into floor vent opening 6.

Body 20 also defines a mounting ledge 50 that projects inwardly from inner surface 28 of body 20. Mounting ledge 50 receives a locking finger 52 defined by the upper portion of duct boot 4 to secure duct boot 4 to connector frame 2. Duct boot 4 will typically define a plurality of spaced locking fingers 52. Locking fingers 52 may be formed in duct boot 4 by using a button punch or a snap lock punch tool on the sidewall of duct boot 4 to form outwardly bent portions of the boot sidewall material. Each locking finger 52 has a tapered portion of sidewall above the finger tip that helps position duct boot 4 into connector frame 2. Locking fingers 52 are configured to be received by mounting ledge 50 in a one way snap-fit connection such that duct boot 4 or locking fingers 52 or the top of duct boot 4 are at least partially compressed to fit locking fingers 52 through opening 6. Once locking fingers 52 are moved above mounting ledge 50, locking fingers 52 snap back outwardly to a position above ledge 50. Duct boot 4 also may be mounted without such compression by pivoting duct boot 4 into connector frame 2.

Mounting ledge 50 may be continuous about inner surface 28 of body 20 or may be defined by a plurality of cooperating portions. The individual portions may be spaced apart or connected at tapered ends. The portions may be tapered at the corners of body 20 to provide extra space for duct boot 4 at the corners of connector frame 2. In some embodiments, a support bar 54 or a plurality of support bars 54 extend across connector frame 2. Support bars 54 provide rigidity to connector frame 2. Support bars 54 provide some protection against putting ones foot into the opening. In these embodiments, mounting ledge 50 is not disposed under the locations of support bars 54.

In an optional embodiment, body 20 may be thicker (the dimension between its inner 28 and outer 30 surfaces) above mounting ledge 50 than below mounting ledge.

A plurality of spaced tapered ribs 60 are disposed below mounting ledge 50. Each tapered rib 60 projects inwardly from the inner surface of body 20 below ledge 50. The entirety of cooperating ribs 60 form a funnel that receives duct boot 4. Each tapered rib 60 has an upper end 62 and a lower end 64 with each tapered rib 60 having a width at its upper end 62 that is larger than its width at its lower end 64. The funnel-shaped opening is thus smaller immediately under mounting ledge 50 than at the lower opening. This funnel shape helps locate locking finger 52 tight against the inner surface of mounting ledge 50 when duct boot 4 is pushed up into connector frame 2. The funnel may be one-quarter inch larger in each of the width and length dimensions.

In some configurations, connector frame 2 is provided with a porous filter 8 disposed across opening 22. Filter 8 is primarily intended to catch debris that falls into connector frame 2 while also allowing air flow in both directions. Filter 8 may be connected to body 20 at spaced locations about body 20 and air may move around the edges of filter 8. In some configurations, filter 8 is supported above and spaced from mounting ledge 50 on a plurality of stands 70. In one configuration, stands 70 project up from mounting ledge 50. In another configuration, stands 70 are disposed in recesses 72 defined by outwardly curved portions of the sidewall of body 20. These portions may be disposed above or level with mounting ledge 50. These portions are positioned outward of ledge 50 such that stands 70 do not interfere with duct boot 4. When stands 70 are disposed in recesses 72, filter 8 includes tabs 74 that extend into these recesses to bring filter 8 into contact with stands 70. Tabs 74 may be welded or melted or adhesively connected to stands 70. Locating filter 8 above mounting ledge 50 allows duct boot 4 to be snapped into place while filter 8 remains installed. A further embodiment uses a filter ledge projecting inwardly from body 20 above mounting ledge 50. The filter ledge supports edge portions of filter 8.

In some configurations, seal 10 extends across opening 22. As shown in FIG. 8, seal 10 may be disposed above filter 8 and may be connected to the top of flange 40. Seal 10 prevents debris from falling into connector frame 2.

FIGS. 9 and 10 depict alternate configurations wherein the connector frame 102 is formed from sheet metal. The metal connector frame 102 includes a flange 104 and a hook 106 that forms a pocket 108. A bent lip 110 formed from portions of the top of duct boot 4 is received in pocket 108 to support duct boot 4 from connector frame 102.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. A connector frame for mounting a duct boot to a floor at a floor vent opening; the connector frame comprising:
a body defining an opening; the body defining an upper end and a lower end; the body having an inner surface and an outer surface;
a flange projecting outwardly from the upper end of the body; the flange adapted to be disposed on the upper surface of the floor; and
a mounting ledge projecting inwardly from the inner surface of the body; the mounting ledge adapted to receive a projection from the duct boot to secure the duct boot to the connector frame.

2. The connector frame of claim 1, wherein the flange is continuous about the body.

3. The connector frame of claim 1, further comprising a plurality of spaced positioning ribs projecting outwardly from the outer surface of the body under the flange.

4. The connector frame of claim 1, further comprising a plurality of spaced tapered ribs disposed below the mounting ledge; each of the tapered ribs projecting inwardly from the inner surface of the body; each of the tapered ribs having an upper end and a lower end; the upper ends of the tapered ribs being closer to the mounting ledge than the lower ends of the tapered ribs; and each of the tapered ribs having a width at its upper end that is larger than its width at its lower end.

5. The connector frame of claim 1, wherein the body has a thickness between its inner and outer surfaces; the body thickness being greater above the mounting ledge than below the mounting ledge.

6. The connector frame of claim 1, wherein the mounting ledge is defined by a plurality of mounting ledge portions.

7. The connector frame of claim 6, wherein at least two of the mounting ledge portions meet in a corner of the body; the two portions being tapered.

8. The connector frame of claim 6, wherein at least two of the mounting ledge portions are spaced apart.

9. The connector frame of claim 1, further comprising a support bar disposed across the opening from one portion of the upper end of the body to another portion of the upper end of the body.

10. The connector of claim 9, wherein no portion of the mounting ledge is disposed under the support bar.

11. The connector of claim 1, further comprising a filter extending across the opening; the filter disposed above the mounting ledge.

12. The connector of claim 11, wherein the body defines a plurality of raised stands; the filter being carried by the plurality of raised stands.

13. The connector of claim 12, wherein the plurality of raised stands space the filter from the mounting ledge.

14. The connector of claim 13, wherein the body defines a plurality of recesses above and outward of the mounting ledge; the raised stands being disposed in the recesses.

15. The connector of claim 1, further comprising a seal extending across the opening.

16. The connector of claim 15, wherein the seal is disposed above the mounting ledge.

17. The connector of claim 16, further comprising a filter disposed under the seal and above the mounting ledge.

18. The connector of claim 16, wherein the seal is disposed on top of the flange.

19. A mounting configuration for a duct boot at a floor vent opening; the mounting configuration comprising:
a duct boot having an upper end;
a floor defining a floor vent opening;
a connector frame for mounting a duct boot to a floor at a floor vent opening; the connector frame secured to the floor and at least partially disposed in the floor vent opening;
the connector frame having a body that defines an opening; the body defining an upper end and a lower end; the body having an inner surface and an outer surface; a flange projecting outwardly from the upper end of the body; the flange connected to the floor;
the connector frame also having a mounting ledge projecting inwardly from the inner surface of the body; and
the duct boot being secured to the mounting ledge.

20. The mounting configuration of claim 19, wherein the duct boot defines a locking finger disposed on the mounting ledge.
